(19) United States
(12) Patent Application Publication
(10) Pub. No.: US 2025/0330547 A1
(43) Pub. Date: Oct. 23, 2025

(54) IMAGE FORMING APPARATUS, IMAGE PROCESSING METHOD, AND NON-TRANSITORY RECORDING MEDIUM

(71) Applicant: Mika INOUE, Kanagawa (JP)

(72) Inventor: Mika INOUE, Kanagawa (JP)

(21) Appl. No.: 19/084,208

(22) Filed: Mar. 19, 2025

(30) Foreign Application Priority Data
Apr. 17, 2024 (JP) 2024-067103

(51) Int. Cl. H04N 1/409; G06T 5/60

(52) U.S. Cl. CPC H04N 1/4095; G06T 5/60; G06T 2207/10008; G06T 2207/20081; G06T 2207/30176

(57) ABSTRACT

An image forming apparatus includes: a scanner to read a document to obtain first read data; and circuitry to acquire a training condition relating to the first read data, generate training data including the first read data and the training condition to be used for training processing based on machine learning, and perform show-through correction on second read data read by the scanner, using a trained model generated by the training processing using the training data.

### CROSS-REFERENCE TO RELATED APPLICATION

This patent application is based on and claims priority pursuant to 35 U.S.C. § 119 (a) to Japanese Patent Application No. 2024-067103, filed on Apr. 17, 2024, in the Japan Patent Office, the entire disclosure of which is hereby incorporated by reference herein.

### BACKGROUND

### Technical Field

The present invention relates to an image forming apparatus, an image processing method, and a non-transitory recording medium.

### Related Art

In image data obtained by a reading device such as a scanner reading a document, a phenomenon called show-through may occur in which an image on the surface on the back side of the read surface (front surface) of the document is captured.

### SUMMARY

According to one aspect, an image forming apparatus includes a scanner that reads a document to obtain first read data; and circuitry. The circuitry acquires a training condition relating to the first read data, generates training data including the first read data and the training condition to be used for training processing based on machine learning, and performs show-through correction on second read data read by the scanner, using a trained model generated by the training processing using the training data.

According to one aspect, an image processing method includes reading a document to obtain first read data; acquiring a training condition relating to the first read data; generating training data including the first read data and the training condition to be used for training processing based on machine learning; and performing show-through correction on second read data obtained by the reading, using a trained model generated by the training processing using the training data.

According to one aspect, a non-transitory recording medium stores a plurality of instructions which, when executed by one or more processors, causes the one or more processors to perform an image processing method including reading a document to obtain first read data; acquiring a training condition relating to the first read data; generating training data including the first read data and the training condition to be used for training processing based on machine learning; and performing show-through correction on second read data obtained by the reading, using a trained model generated by the training processing using the training data.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a general arrangement of an information processing system;

FIG. 2 is a diagram illustrating an example of a hardware configuration of an image forming apparatus;

FIG. 3 is a diagram illustrating an example of a hardware configuration of a machine learning server;

FIG. 4 is a diagram illustrating an example of configurations of functional blocks of the image forming apparatus and the machine learning server;

FIG. 5 is a flowchart presenting an example of a flow of training processing of the information processing system;

FIG. 6 is a flowchart presenting another example of the flow of the training processing of the information processing system; and

FIG. 7 is a flowchart presenting an example of a flow of show-through correction processing of the image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of an image forming apparatus, an image processing method, and a program will be described in detail with reference to the drawings.

### General Arrangement of Information Processing System

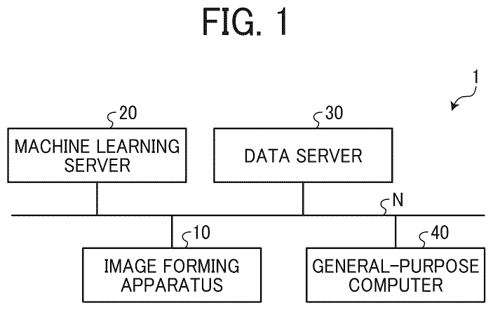

FIG. 1 is a diagram illustrating an example of a general arrangement of an information processing system 1. The general arrangement of the information processing system 1 will be described with reference to FIG. 1.

The information processing system 1 illustrated in FIG. 1 includes an image forming apparatus 10 as an example of an information processing apparatus, a machine learning server 20, a data server 30, and a general-purpose computer 40. These apparatuses can perform data transmission or reception to or from one another via a network N that is a local area network (LAN) or the Internet. The network N may include a wired or wireless network.

The image forming apparatus 10 is an image forming apparatus such as a multifunction peripheral (MFP) or a facsimile (FAX) machine that can perform a reading operation on a document. The image forming apparatus 10 performs show-through correction on read data using a trained model (described later) generated in training processing performed by the machine learning server 20. The show-through correction is correction processing for reducing or eliminating show-through occurring in read data as described above.

The machine learning server 20 is a server apparatus that performs training processing based on machine learning using training data on read data and generates a trained model. The training data used in the training processing performed by the machine learning server 20 may be training data generated by the image forming apparatus 10, or may be training data generated by the data server 30 using read data obtained by the image forming apparatus 10.

The data server 30 is a server apparatus that collects read data from an external apparatus such as the image forming apparatus 10, generates training data to be used in the training processing performed by the machine learning server 20, and transmits the training data to the machine learning server 20.

The general-purpose computer 40 is an information processing apparatus such as a personal computer (PC) that transmits print data to be printed out by the image forming apparatus 10 to the image forming apparatus 10.

While the trained model is generated by the machine learning server 20, the trained model may be generated by an apparatus other than the machine learning server 20. The image forming apparatus 10 may have a function of training processing and generate a trained model.

### Hardware Configuration of Image Forming Apparatus

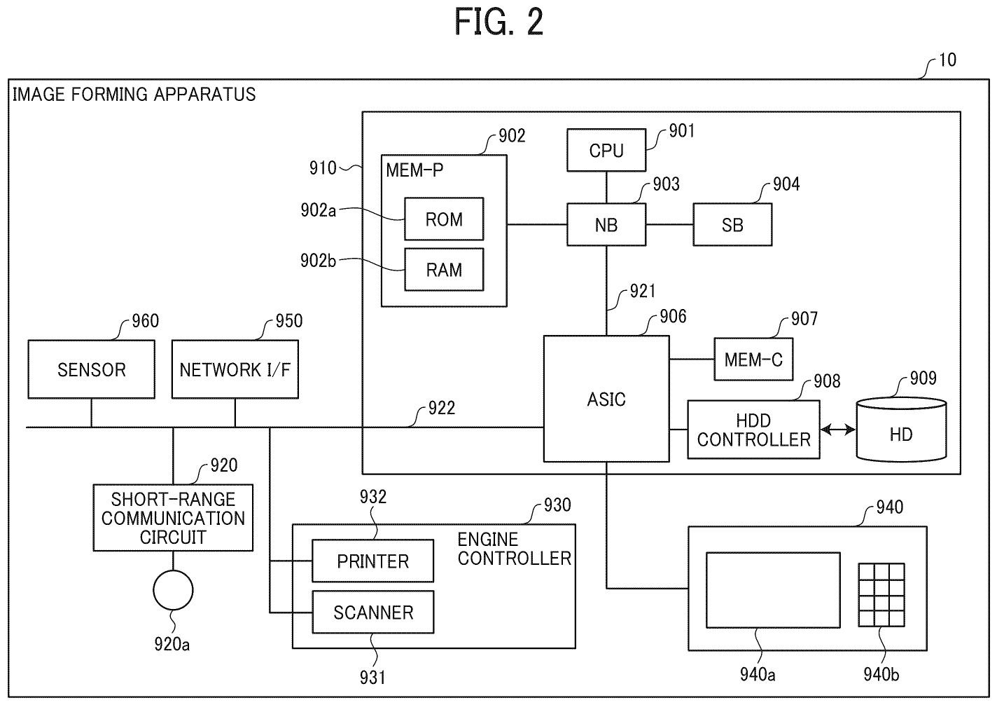

FIG. 2 is a diagram illustrating an example of a hardware configuration of the image forming apparatus 10. The hardware configuration of the image forming apparatus 10 will be described with reference to FIG. 2.

As illustrated in FIG. 2, the image forming apparatus 10 includes a controller 910, a short-range communication circuit 920, an engine controller 930, a control panel 940, a network interface (I/F) 950, and a sensor 960.

The controller 910 includes a central processing unit (CPU) 901 as a main processor, a system memory (MEM-P) 902, a northbridge (NB) 903, a southbridge (SB) 904, an application-specific integrated circuit (ASIC) 906, a local memory (MEM-C) 907, a hard disk drive (HDD) controller 908, and a hard disk (HD) 909. The NB 903 and the ASIC 906 are connected to each other by an accelerated graphics port (AGP) bus 921.

The CPU 901 is an arithmetic device that performs the entire control of the image forming apparatus 10. The NB 903 is a bridge for connecting the CPU 901 to the MEM-P 902, the SB 904, and the AGP bus 921. The NB 903 includes a memory controller that controls reading or writing from or to the MEM-P 902, a peripheral component interconnect (PCI) master, and an AGP target.

The MEM-P 902 includes a read-only memory (ROM) 902a that is a memory for storing programs and data for implementing various functions of the controller 910, and a random-access memory (RAM) 902b used as a storage area for loading a program or data, or a storage area for rendering print data. The program stored in the RAM 902b may be stored in any computer-readable recording medium, such as a compact disc read-only memory (CD-ROM), compact disc recordable (CD-R), or digital versatile disc (DVD), in a file format installable or executable by the computer, for distribution.

The SB 904 is a bridge that connects the NB 903 to a PCI device or a peripheral device. The ASIC 906 is an integrated circuit (IC) dedicated to image processing. The ASIC 906 includes hardware components for image processing, and connects the AGP bus 921, a PCI bus 922, the HDD controller 908, and the MEM-C 907 with one another. The ASIC 906 includes a PCI target, an AGP master, an arbiter (ARB) as a central processor of the ASIC 906, a memory controller for controlling the MEM-C 907, a plurality of direct memory access controllers (DMACs) that can convert coordinates of image data with a hardware logic, and a PCI unit that transfers data between the ASIC 906 and a scanner 931 or a printer 932 via the PCI bus 922. The ASIC 906 may be connected to a Universal Serial Bus (USB) interface, or the Institute of Electrical and Electronics Engineers 1394 (IEEE1394) interface.

The MEM-C 907 is a local memory used as a buffer for image data to be copied or a buffer for coding. The HD 909 is a storage for storing image data, font data used in printing, and forms. The HDD controller 908 controls reading or writing of data from or to the HD 909 under the control of the CPU 901. The HDD controller 908 and the HD 909 may be replaced by a solid state drive (SSD).

The AGP bus 921 is a bus interface for a graphics accelerator card. The AGP bus 921 has been proposed to accelerate graphics processing. Through directly accessing the MEM-P 902 by high throughput, the speed of the graphics accelerator card increases.

The short-range communication circuit 920 is a communication circuit in compliance with such as near field communication (NFC) or BLUETOOTH. The short-range communication circuit 920 is electrically connected to the ASIC 906 via the PCI bus 922. The short-range communication circuit 920 is connected to an antenna 920a for wireless communication.

The engine controller 930 includes the scanner 931 and the printer 932. The scanner 931 performs a reading operation on a document to obtain read data. The printer 932 performs printing on a print sheet. The scanner 931 and the printer 932 have an image processing function, such as error diffusion or gamma conversion.

The control panel 940 includes a panel display 940a and a hard keypad 940b. The panel display 940a is implemented by, for example, a touch panel that displays current set values or a selection screen to receive a user input. The hard keypad 940b includes a numeric keypad that receives set values of various image forming parameters such as an image density parameter and a start key that receives an instruction for starting copying. The control panel 940 is an input unit (input device).

In response to an instruction to select a specific application through the control panel 940, for example, using a mode switch key, the image forming apparatus 10 selectively performs a document box function, a copy function, a print function, and a facsimile communication function. When the document box function is selected, the image forming apparatus 10 operates in a document box mode. When the copy function is selected, the image forming apparatus 10 operates in a copy mode. When the print function is selected, the image forming apparatus 10 operates in a print mode. When the facsimile communication function is selected, the image forming apparatus 10 operates in a facsimile communication mode.

The network I/F 950 is an interface for performing data transmission or reception via a network, in compliance with, for example, ETHERNET or Transmission Control Protocol (TCP)/Internet Protocol (IP). The network I/F 950 is electrically connected to the ASIC 906 via the PCI bus 922.

The sensor 960 is a sensor for detecting, for example, the sheet type or sheet thickness of a document to be read by the scanner 931, the temperature or humidity, or the occurrence of dewing.

The hardware configuration of the image forming apparatus 10 illustrated in FIG. 2 is just one example, and the image forming apparatus 10 does not have to include all of the components illustrated in FIG. 2, or may include any other components.

### Hardware Configuration of Machine Learning Server

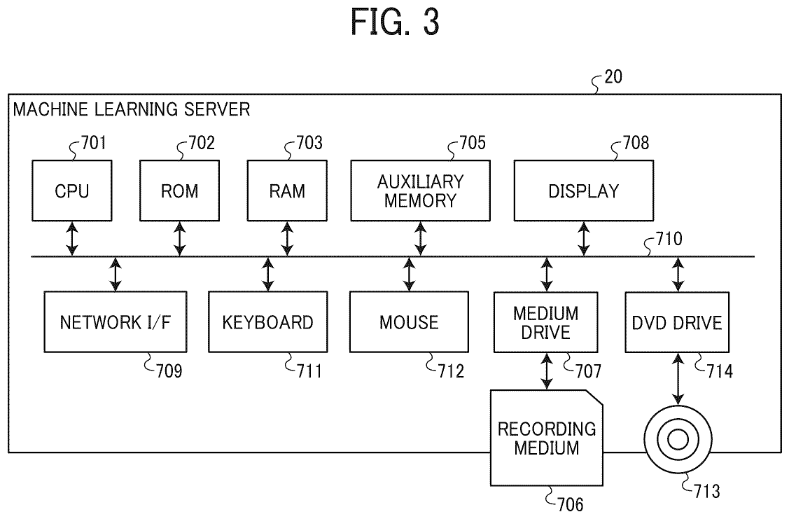

FIG. 3 is a diagram illustrating an example of a hardware configuration of the machine learning server 20. The hardware configuration of the machine learning server 20 will be described with reference to FIG. 3.

As illustrated in FIG. 3, the machine learning server 20 includes a CPU 701, a ROM 702, a RAM 703, an auxiliary memory 705, a medium drive 707, a display 708, a network I/F 709, a keyboard 711, a mouse 712, and a DVD drive 714.

The CPU 701 is an arithmetic device that controls the entire operation of the machine learning server 20. The ROM 702 is a non-volatile memory that stores a program for the machine learning server 20. The RAM 703 is a volatile memory that is used as a work area of the CPU 701.

The auxiliary memory 705 is a memory such as a HDD or a SSD that stores, for example, various data and programs. The medium drive 707 controls reading or writing of data from or to a recording medium 706 such as a flash memory under the control of the CPU 701.

The display 708 is a display device implemented by a liquid crystal display (LCD), an organic electro-luminescence (EL) display, etc. The display 708 displays various types of information such as a cursor, a menu, a window, characters, or an image.

The network I/F 709 is an interface for data transmission or reception to or from an external apparatus, such as the image forming apparatus 10, the data server 30, or the general-purpose computer 40, via the network N. The network I/F 709 is, for example, a network interface card (NIC) compliant with ETHERNET and can establish wired or wireless communications in compliance with TCP/IP.

The keyboard 711 is an example of an input device used for inputting characters or numbers, selecting an instruction from options, or moving a cursor. The mouse 712 is another example of the input device used for selecting an instruction from options or executing the instruction, selecting a subject to be processed, or moving the cursor.

The DVD drive 714 controls reading or writing of data from or to a DVD 713 such as a digital versatile disk read-only memory (DVD-ROM) or a digital versatile disk recordable (DVD-R) that is an example of a removable storage medium.

The CPU 701, the ROM 702, the RAM 703, the auxiliary memory 705, the medium drive 707, the display 708, the network I/F 709, the keyboard 711, the mouse 712, and the DVD drive 714 are communicably connected to each other through a bus 710 such as an address bus or a data bus.

The hardware configuration of the machine learning server 20 illustrated in FIG. 3 is just one example, and the machine learning server 20 does not have to include all of the components illustrated in FIG. 3, or may include any other components. The machine learning server 20 is not limited to be implemented by the one information processing apparatus illustrated in FIG. 3, and may be implemented by a plurality of information processing apparatuses. The hardware configurations of the data server 30 and the general-purpose computer 40 also conform to the hardware configuration illustrated in FIG. 3.

### Configurations and Operations of Functional Blocks of Image Forming Apparatus and Machine Learning Server

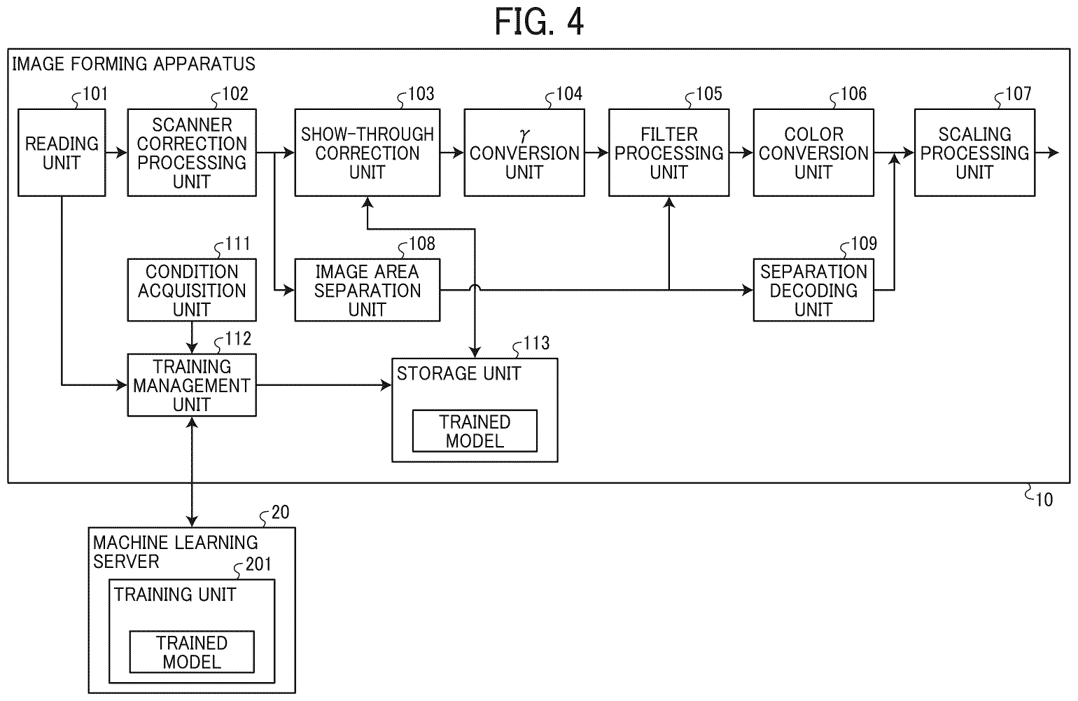

FIG. 4 is a diagram illustrating an example of configurations of functional blocks of the image forming apparatus 10 and the machine learning server 20. The configurations and operations of the functional blocks of the image forming apparatus 10 and the machine learning server 20 will be described with reference to FIG. 4.

As illustrated in FIG. 4, the image forming apparatus 10 includes a reading unit 101, a scanner correction processing unit 102, a show-through correction unit 103 (correction unit), a γ conversion unit 104, a filter processing unit 105, a color conversion unit 106, a scaling processing unit 107, an image area separation unit 108, a separation decoding unit 109, a condition acquisition unit 111 (acquisition unit), a training management unit 112 (generation unit), and a storage unit 113.

The reading unit 101 is a functional unit that performs a reading operation on a document to be read to obtain read data (image data). The reading unit 101 is implemented by the scanner 931 illustrated in FIG. 2.

The scanner correction processing unit 102 is a functional unit that corrects reading unevenness or the like that occurs due to a mechanism of the scanner 931, such as shading, for the read data read by the reading unit 101.

The show-through correction unit 103 is a functional unit that refers to a trained model stored in the storage unit 113 and performs show-through correction on the read data corrected by the scanner correction processing unit 102 using the trained model. Specifically, when performing the show-through correction on the read data, the show-through correction unit 103 acquires the same condition as a training condition included in training data used to generate the trained model, and performs the show-through correction using the trained model based on the read data and the condition. Accordingly, correction corresponding to the condition at the time of the show-through correction can be performed.

The trained model may receive, for example, the read data and the condition as inputs, and output data obtained by performing the show-through correction on the read data, or may output various appropriate parameters, coefficients, or the like used for the show-through correction. When the various parameters or coefficients used for the show-through correction are output from the trained model, the show-through correction unit 103 may perform the show-through correction on the read data using the parameters or coefficients. In this case, a known method may be used for the show-through correction.

Alternatively, a condition similar to a training condition included in training data and used to generate a trained model may be acquired by the condition acquisition unit 111. A method of acquiring the condition will be described later in the description of the condition acquisition unit 111.

The γ conversion unit 104 is a functional unit that performs correction (gamma correction) of a scanner characteristic for the read data on which the show-through correction has been performed by the show-through correction unit 103 so that the brightness of the read data changes linearly.

The filter processing unit 105 is a functional unit that performs image processing on the read data corrected by the γ conversion unit 104 to make an image clear and smooth by correcting a modulation transfer function (MTF) characteristic of the scanner 931 or changing a frequency characteristic of the read data to prevent moire.

The color conversion unit 106 is a functional unit that performs color conversion on the read data on which the image processing has been performed by the filter processing unit 105 to obtain data in a predetermined color space.

The scaling processing unit 107 is a functional unit that performs scaling processing to enlarge or reduce the read data on which the color conversion has been performed by the color conversion unit 106 by changing the aspect ratio.

The image area separation unit 108 is a functional unit that extracts a feature area included in the read data corrected by the scanner correction processing unit 102. For example, the image area separation unit 108 extracts a dot portion formed by general printing, extracts an edge portion of a character or the like, determine whether the read data is chromatic or achromatic, or determines a white background such as whether a background image is white.

The separation decoding unit 109 is a functional unit that decodes an image area separation signal from the image area separation unit 108 into an information amount used for subsequent processing and outputs the information amount.

The condition acquisition unit 111 is a functional unit that acquires a training condition to be included in training data by the training management unit 112. Expected examples of the training condition include the sheet type or sheet thickness having a particularly large influence on show-through, the type or color of toner or ink, the temperature or humidity inside the image forming apparatus 10, the occurrence of dewing inside the image forming apparatus 10, data and information on a processing condition when the read data has been processed (density adjustment, background removal, color adjustment, or the like), an edge amount calculated for the read data (in particular, focusing on low-frequency edges of a show-through portion and a low-contrast portion), and binarized data of the read data. For the sheet type of the document among the above-described training conditions, for example, a reflective sheet such as coated paper tends to be less likely to have show-through. For the sheet thickness of the document, a thinner sheet tends to be more likely to have show-through.

The condition acquisition unit 111 may acquire, as the training condition, at least one of the sheet type or sheet thickness of the document, and the type or color of the toner or ink. The condition acquisition unit 111 may acquire, as the training condition, at least one of the temperature or humidity inside the image forming apparatus 10, the occurrence of dewing, and the data obtained when the read data has been processed. The condition acquisition unit 111 may acquire, as the training condition, at least one of the edge amount calculated for the read data and the binarized data of the read data.

For example, the condition acquisition unit 111 may acquire the sheet type or sheet thickness of the document, the type or color of the toner or ink, or the information on the processing condition for processing the read data among the above-described training conditions, from setting information input in advance through the control panel 940. For example, the condition acquisition unit 111 may acquire the sheet type or sheet thickness of the document, the temperature or humidity inside the image forming apparatus 10, or the occurrence of dewing inside the image forming apparatus 10 among the above-described training conditions, from information detected by the sensor 960. For example, the condition acquisition unit 111 may acquire the data when processed, the calculated edge amount, or the binarized data among the above-described training conditions for the read data read by the reading unit 101. In order for the training management unit 112 to generate various training data, the condition acquisition unit 111 may acquire the above-described training condition in various states or after intentionally changing the training condition.

The training management unit 112 is a functional unit that generates training data using the training condition acquired by the condition acquisition unit 111 as data to be embedded in the read data read by the reading unit 101. That is, the training data includes the read data and the training condition. In this case, the training condition can be regarded as a feature amount for the training data. Alternatively, the read data may be regarded as a feature value. The training management unit 112 transmits the generated training data to the machine learning server 20 via the network I/F 950 to cause the machine learning server 20 to perform training processing based on machine learning using the generated training data. The training management unit 112 receives a trained model generated by the training processing performed by the machine learning server 20 via the network I/F 950 and causes the storage unit 113 to store the trained model.

When the training processing performed by the machine learning server 20 is, for example, supervised learning, image data or the like obtained by properly performing the show-through correction on read data may be assigned as a label to the training data.

The storage unit 113 is a functional unit that stores the trained model or the like generated by the training processing performed by the machine learning server 20. The storage unit 113 is implemented by the HD 909 illustrated in FIG. 2.

The scanner correction processing unit 102, the show-through correction unit 103, the γ conversion unit 104, the filter processing unit 105, the color conversion unit 106, the scaling processing unit 107, the image area separation unit 108, the separation decoding unit 109, the condition acquisition unit 111, and the training management unit 112 described above are implemented by the CPU 901 illustrated in FIG. 2 executing a program. At least one or some of the scanner correction processing unit 102, the show-through correction unit 103, the γ conversion unit 104, the filter processing unit 105, the color conversion unit 106, the scaling processing unit 107, the image area separation unit 108, the separation decoding unit 109, the condition acquisition unit 111, and the training management unit 112 may be implemented by a hardware circuit such as a field-programmable gate array (FPGA) or an ASIC.

While the show-through correction unit 103 performs the show-through correction before the gamma correction performed by the γ conversion unit 104 in the example illustrated in FIG. 4, the order is not limited thereto. The show-through correction may be performed after the γ conversion unit 104 performs the gamma correction or the like, or the show-through correction may be performed before or after the color conversion unit 106 performs the color conversion.

While the functional units of the image forming apparatus 10 illustrated in FIG. 4 are conceptually illustrated functions, the functional units are not limited to such a configuration. That is, the functional units of the image forming apparatus 10 do not have to be implemented as distinct software modules as the blocks illustrated in FIG. 4. The functions of the functional units may be implemented as a whole when a program is executed by the image forming apparatus 10. For example, a plurality of functional units illustrated as independent functional units in the image forming apparatus 10 illustrated in FIG. 4 may be implemented as one functional unit. In contrast, a function of one functional unit in the image forming apparatus 10 illustrated in FIG. 4 may be divided into a plurality of functions and implemented as a plurality of functional units.

As illustrated in FIG. 4, the machine learning server 20 includes a training unit 201.

The training unit 201 is a functional unit that generates a trained model by training processing based on machine learning, using the training data received from the training management unit 112 via the network I/F 709.

The trained model is, for example, a model that receives read data to which the above-described condition has been added as an input, and outputs data obtained by performing the show-through correction on the read data. The training unit 201 transmits the generated trained model to the image forming apparatus 10 via the network I/F 709.

As described above, the trained model may output the various appropriate parameters or coefficients used for the show-through correction. The training unit 201 may perform the training processing using training data generated by the data server 30 instead of or in addition to using the training data generated by the image forming apparatus 10.

### Flow of Training Processing of Information Processing System

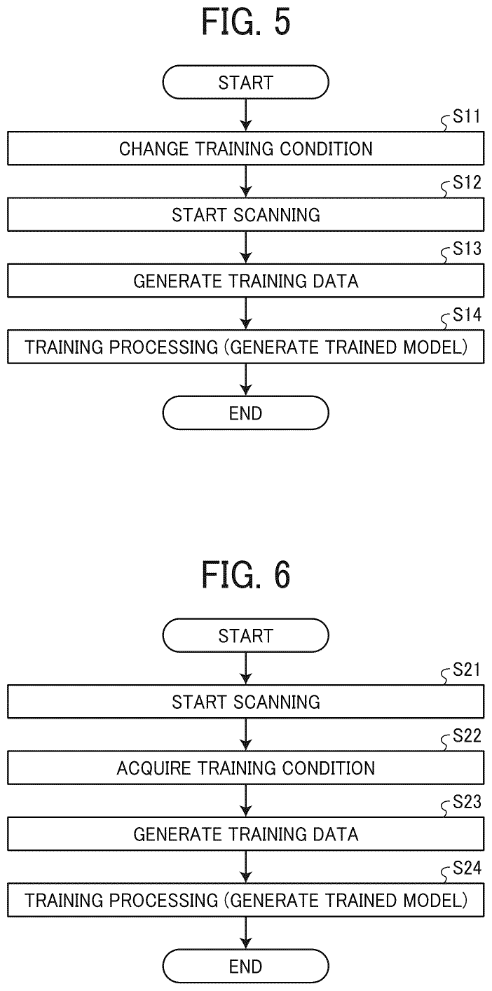

FIG. 5 is a flowchart presenting an example of a flow of training processing of the information processing system 1. FIG. 6 is a flowchart presenting another example of the flow of the training processing of the information processing system 1. The flows of the training processing of the information processing system 1 will be described with reference to FIGS. 5 and 6. An operation of acquiring a training condition before the scanner 931 performs a reading operation will be described with reference to FIG. 5.

In step S11, the condition acquisition unit 111 of the image forming apparatus 10 acquires a training condition changed to various contents to be included in training data by the training management unit 112. For example, the condition acquisition unit 111 acquires the sheet type or sheet thickness of a document, the type or color of toner or ink, or information on a processing condition for processing read data among training conditions, from setting information input in advance through the control panel 940. The processing proceeds to step S12.

In step S12, the reading unit 101 of the image forming apparatus 10 performs a reading operation (scanning) on a document to be read to obtain read data (first read data). The read data may be read data corrected by the scanner correction processing unit 102. The processing proceeds to step S13.

In step S13, the training management unit 112 of the image forming apparatus 10 generates training data using the training condition acquired by the condition acquisition unit 111 as data to be embedded in the read data read by the reading unit 101. The training management unit 112 transmits the generated training data to the machine learning server 20 via the network I/F 950 to cause the machine learning server 20 to perform machine learning using the generated training data. The processing proceeds to step S14.

In step S14, the training unit 201 of the machine learning server 20 generates a trained model by performing training processing based on machine learning using the training data received from the training management unit 112 via the network I/F 709. The training unit 201 transmits the generated trained model to the image forming apparatus 10 via the network I/F 709. The training management unit 112 of the image forming apparatus 10 receives the trained model generated by the training processing performed by the machine learning server 20 via the network I/F 950 and causes the storage unit 113 to store the trained model.

With reference to FIG. 6, a description will be given of an operation of generating training data using various types of information (for example, the sheet type or sheet thickness of a document, the temperature or humidity inside the image forming apparatus 10, or the occurrence of dewing inside the image forming apparatus 10) detected by the sensor 960 as a training condition, or using data when processed, a calculated edge amount, or binarized data as a training condition for read data, after the reading unit 101 performs a reading operation on a document.

In step S21, the reading unit 101 of the image forming apparatus 10 performs a reading operation (scanning) on a document to be read to obtain read data (first read data). The read data may be read data corrected by the scanner correction processing unit 102. The processing proceeds to step S22.

In step S22, the condition acquisition unit 111 of the image forming apparatus 10 acquires a training condition to be included in training data by the training management unit 112. For example, the condition acquisition unit 111 may acquire information detected by the sensor 960 after the reading unit 101 performs the reading operation for the sheet type or sheet thickness of the document, the temperature or humidity inside the image forming apparatus 10, or the occurrence of dewing inside the image forming apparatus 10 among the training conditions. Alternatively, the condition acquisition unit 111 may acquire the data when processed, the calculated edge amount, or the binarized data among the training conditions for the read data read by the reading unit 101. The processing proceeds to step S23.

In step S23, the training management unit 112 of the image forming apparatus 10 generates training data using the training condition acquired by the condition acquisition unit 111 as data to be embedded in the read data read by the reading unit 101. The training management unit 112 transmits the generated training data to the machine learning server 20 via the network I/F 950 to cause the machine learning server 20 to perform machine learning using the generated training data. The processing proceeds to step S24.

In step S24, the training unit 201 of the machine learning server 20 generates a trained model by performing training processing based on machine learning using the training data received from the training management unit 112 via the network I/F 709. The training unit 201 transmits the generated trained model to the image forming apparatus 10 via the network I/F 709. The training management unit 112 of the image forming apparatus 10 receives the trained model generated by the training processing performed by the machine learning server 20 via the network I/F 950 and causes the storage unit 113 to store the trained model.

While the training condition is acquired before the reading operation on the document in FIG. 5 and the training condition is acquired after the reading operation in FIG. 6, the timing at which the training condition is acquired is not limited thereto. The training condition may be acquired before and after the reading operation as desired.

### Flow of Show-through Correction Processing of Image Forming Apparatus

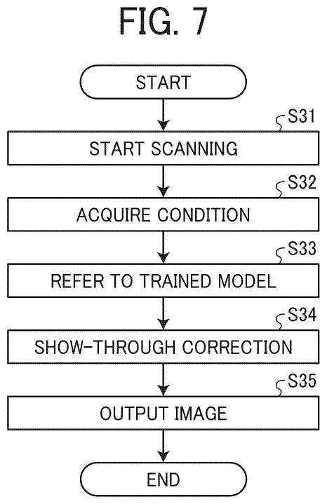

FIG. 7 is a flowchart presenting an example of a flow of show-through correction processing of the image forming apparatus 10. The flow of the show-through correction processing of the image forming apparatus 10 will be described with reference to FIG. 7.

The user performs an operation of instructing a scan operation or a copy operation on a document through the control panel 940. In step S31, the reading unit 101 of the image forming apparatus 10 performs a reading operation (scanning) on a document to be corrected to obtain read data (second read data). The scanner correction processing unit 102 corrects reading unevenness or the like that occurs due to a mechanism of the scanner 931, such as shading, for the read data read by the reading unit 101. The processing proceeds to step S32.

In step S32, when performing the show-through correction on the read data read by the reading unit 101, the show-through correction unit 103 of the image forming apparatus 10 acquires the same condition as the training condition included in the training data used to generate the trained model. The condition acquisition unit 111 may acquire the same condition as the training condition included in the training data used to generate the trained model. The method of acquiring the condition is an operation similar to the operation that the condition acquisition unit 111 acquires the training condition as described above. The processing proceeds to step S33.

In step S33, the show-through correction unit 103 refers to the trained model stored in the storage unit 113. The processing proceeds to step S34.

In step S34, the show-through correction unit 103 performs the show-through correction using the trained model based on the read data read by the reading unit 101 and the condition. At this time, processing is performed so as to intensively correct an image area of low-frequency edges such as a show-through portion and a low-contrast portion in particular. The processing proceeds to step S35.

In step S35, the γ conversion unit 104, the filter processing unit 105, the color conversion unit 106, and the scaling processing unit 107 further perform processing on the read data on which the show-through correction has been performed by the show-through correction unit 103.

When the copy operation is designated, the read data is transmitted to the printer 932 and an image is formed.

As described above, in the image forming apparatus 10, the reading unit 101 performs a reading operation on a document to obtain read data (first read data), the condition acquisition unit 111 acquires a training condition relating to the read data, the training management unit 112 generates training data including the read data and the training condition to be used for training processing based on machine learning, and the show-through correction unit 103 performs show-through correction on read data (second read data) to be corrected read by the reading unit 101, using a trained model generated by the training processing using the training data. Accordingly, the show-through correction can be performed in accordance with various conditions relating to the read data.

When at least one of the functional units of the image forming apparatus 10 according to the above-described embodiment is implemented by execution of a program, such a program may be provided by being installed in a ROM or any desired memory of the image forming apparatus 10 in advance. Alternatively, the program executed by the image forming apparatus 10 according to the above-described embodiment may be stored in a computer-readable recording medium, such as a CD-ROM, a flexible disk (FD), a CD-R, or a DVD, in a file format installable or executable by the computer, for distribution. Still alternatively, the program executed by the image forming apparatus 10 according to the above-described embodiment may be stored on a computer connected to a network such as the Internet, and provided by being downloaded via the network. Yet alternatively, the program executed by the image forming apparatus 10 according to the above-described embodiment may be provided or distributed via a network such as the Internet. The program executed by the image forming apparatus 10 according to the above-described embodiment has a module configuration including at least one of the above-described functional units. As the CPU 901 reads the program from the above-described memory (for example, the MEM-P 902 or the HD 909) and executes the program, each of the above-described functional units is loaded onto the main memory (work area) to operate as the functional unit.

Aspects of the present invention are as follows.

According to Aspect 1, an image forming apparatus includes a reading unit that performs a reading operation on a document to obtain first read data; an acquisition unit that acquires a training condition relating to the first read data; a generation unit that generates training data including the first read data and the training condition to be used for training processing based on machine learning; and a correction unit that performs show-through correction on second read data to be corrected read by the reading unit, using a trained model generated by the training processing using the training data.

According to Aspect 2, in the image forming apparatus of Aspect 1, the acquisition unit acquires, as the training condition, at least one of a sheet type or a sheet thickness of the document, or a type or a color of toner or ink.

According to Aspect 3, in the image forming apparatus of Aspect 1 or Aspect 2, the acquisition unit acquires, as the training condition, at least one of a temperature or a humidity inside the image forming apparatus, occurrence of dewing, or data obtained when the first read data has been processed.

According to Aspect 4, in the image forming apparatus of any one of Aspect 1 to Aspect 3, the acquisition unit acquires the training condition from setting information input in advance through an input unit.

According to Aspect 5, in the image forming apparatus of any one of Aspect 1 to Aspect 4, the acquisition unit acquires the training condition from information detected by a sensor.

According to Aspect 6, in the image forming apparatus of any one of Aspect 1 to Aspect 5, the acquisition unit acquires, as the training condition, at least one of an edge amount calculated for the first read data or binarized data of the first read data.

According to Aspect 7, in the image forming apparatus of any one of Aspect 1 to Aspect 6, the generation unit generates the training data using the acquired training condition acquired by the acquisition unit, as data to be embedded in the first read data.

According to Aspect 8, in the image forming apparatus of any one of Aspect 1 to Aspect 7, when performing the show-through correction, the correction unit acquires a same condition as the training condition of the training data and performs the show-through correction using the trained model based on the second read data and the condition.

According to Aspect 9, an image processing method includes performing a reading operation on a document to obtain first read data using a reading device; acquiring a training condition relating to the first read data; generating training data including the first read data and the training condition to be used for training processing based on machine learning; and performing show-through correction on second read data to be corrected read by the reading device, using a trained model generated by the training processing using the training data.

According to Aspect 10, a program causes a computer to perform an image processing method including acquiring a training condition relating to first read data obtained by a reading operation performed by a reading device on a document; generating training data including the first read data and the training condition to be used for training processing based on machine learning; and performing show-through correction on second read data to be corrected read by the reading device, using a trained model generated by the training processing using the training data.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
a scanner to read a document to obtain first read data; and
circuitry configured to
acquire a training condition relating to the first read data,
generate training data including the first read data and the training condition to be used for training processing based on machine learning, and
perform show-through correction on second read data read by the scanner, using a trained model generated by the training processing using the training data.

2. The image forming apparatus according to claim 1, wherein the circuitry is configured to acquire, as the training condition, at least one of a sheet type or a sheet thickness of the document, or a type or a color of toner or ink.

3. The image forming apparatus according to claim 1, wherein the circuitry is configured to acquire, as the training condition, at least one of a temperature or a humidity inside the image forming apparatus, occurrence of dewing, or data obtained when the first read data has been processed.

4. The image forming apparatus according to claim 1, wherein the circuitry is configured to acquire the training condition from setting information previously input through an input device.

5. The image forming apparatus according to claim 1, wherein the circuitry is configured to acquire the training condition from information detected by a sensor.

6. The image forming apparatus according to claim 1, wherein the circuitry is configured to acquire, as the training condition, at least one of an edge amount calculated for the first read data or binarized data of the first read data.

7. The image forming apparatus according to claim 1, wherein the circuitry is configured to generate the training data using the acquired training condition as data to be embedded in the first read data.

8. The image forming apparatus according to claim 1, wherein, in performing the show-through correction, the circuitry is configured to acquire a same condition as the training condition of the training data and perform the show-through correction using the trained model based on the second read data and the condition.

9. An image processing method comprising:
reading a document to obtain first read data;
acquiring a training condition relating to the first read data;
generating training data including the first read data and the training condition to be used for training processing based on machine learning; and
performing show-through correction on second read data obtained by the reading, using a trained model generated by the training processing using the training data.

10. A non-transitory recording medium storing a plurality of instructions which, when executed by one or more processors, causes the one or more processors to perform an image processing method comprising:
reading a document to obtain first read data;
acquiring a training condition relating to the first read data;
generating training data including the first read data and the training condition to be used for training processing based on machine learning; and
performing show-through correction on second read data obtained by the reading, using a trained model generated by the training processing using the training data.
